(19) United States
(12) Patent Application Publication
(10) Pub. No.: US 2015/0133281 A1
(43) Pub. Date: May 14, 2015

(54) SHEET PROCESSING APPARATUS

(71) Applicant: Kenichi Hirose, Kanagawa-ken (JP)

(72) Inventor: Kenichi Hirose, Kanagawa-ken (JP)

(21) Appl. No.: 14/537,337

(22) Filed: Nov. 10, 2014

(30) Foreign Application Priority Data
Nov. 13, 2013 (JP) 2013-235001

(51) Int. Cl. B26D 5/28; B65H 7/14

(52) U.S. Cl. CPC B26D 5/28; B65H 7/14
USPC 493/10; 493/22

(57) ABSTRACT

A sheet processing apparatus according to the embodiment has an inspection section to inspect a sheet, a cutting section to cut a sheet in accordance with a result of the inspection by the inspection section, a shape sensor arranged between the inspection section and the cutting section, to detect a shape of the sheet which has entered the cutting section, and a detecting section to detect the number of the sheets which have entered the cutting section, based on the shape of the sheet detected by the shape sensor.

### CROSS-REFERENCE TO RELATED APPLICATION

This application is based upon and claims the benefit of priority from the prior Japanese Patent Application No. 2013-235001, filed on Nov. 13, 2014, the entire contents of which are incorporated herein by reference.

### FIELD

Embodiments of the present invention relate to a sheet processing apparatus.

### BACKGROUND ART

Conventionally a sheet processing apparatus which is provided with a shift sensor to detect a sheet on a conveying path of a sheet is known. This sheet processing apparatus determines whether or not a sheet can be stacked, based on the detection of the sheet by the shift sensor. When determining that the sheet cannot be stacked, the sheet processing apparatus switches a gate on the conveying path to an ejection section.

The detection accuracy of the shift sensor might drop owing to the cutting or break of a sheet during conveyance, the winding-up of a cut piece, or the like. For this reason, when sheets are counted in accordance with the detection result of the shift sensor, counting of the sheets with a high accuracy might become difficult.

### BRIEF DESCRIPTION OF THE DRAWINGS

FIG. 1 is a diagram schematically showing a configuration of a cutting module of a sheet processing apparatus of an embodiment.

FIG. 2 is a diagram schematically showing a configuration of a part of the cutting module of the sheet processing apparatus of the embodiment.

FIG. 3 is a diagram schematically showing a configuration of a control system of the sheet processing apparatus of the embodiment.

FIG. 4A is a diagram showing detection signals of the first shift sensor to the fourth shift sensor when the sheet processing apparatus of the embodiment is normal.

FIG. 4B is a diagram showing detection signals of the first shift sensor to the fourth shift sensor when the sheet processing apparatus of the embodiment is abnormal.

FIG. 5 is a diagram showing a detection signal of the array-shaped optical sensor of the sheet processing apparatus of the embodiment.

### DETAILED DESCRIPTION

A sheet processing apparatus of the present embodiment has an inspection section to inspect a sheet, a cutting section to cut the sheet in accordance with a result of the inspection by the inspection section, a shape sensor arranged between the inspection section and the cutting section, to detect a shape of the sheet which has entered the cutting section, and a detecting section to detect the number of the sheets which have entered the cutting section, based on the shape of the sheet detected by the shape sensor.

Hereinafter, sheet processing apparatuses of embodiments will be described with reference to the appended drawings.

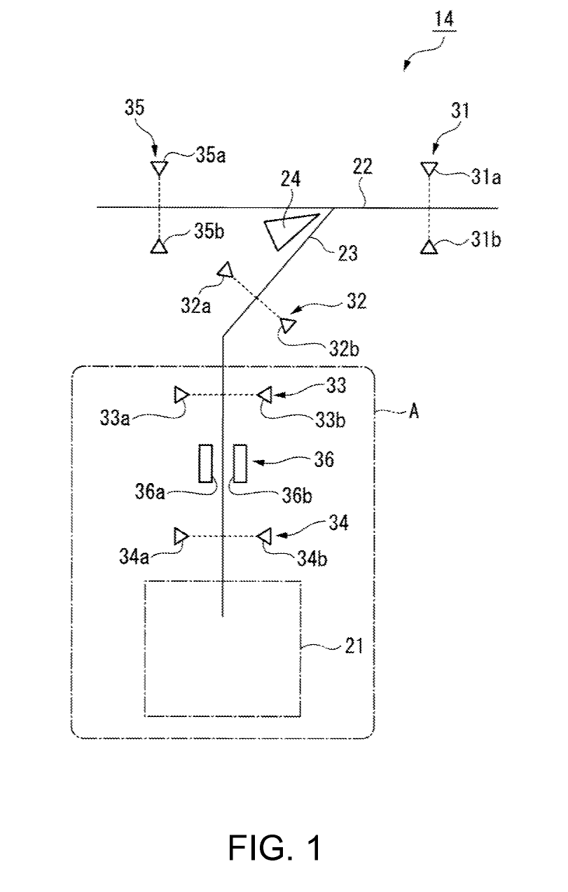

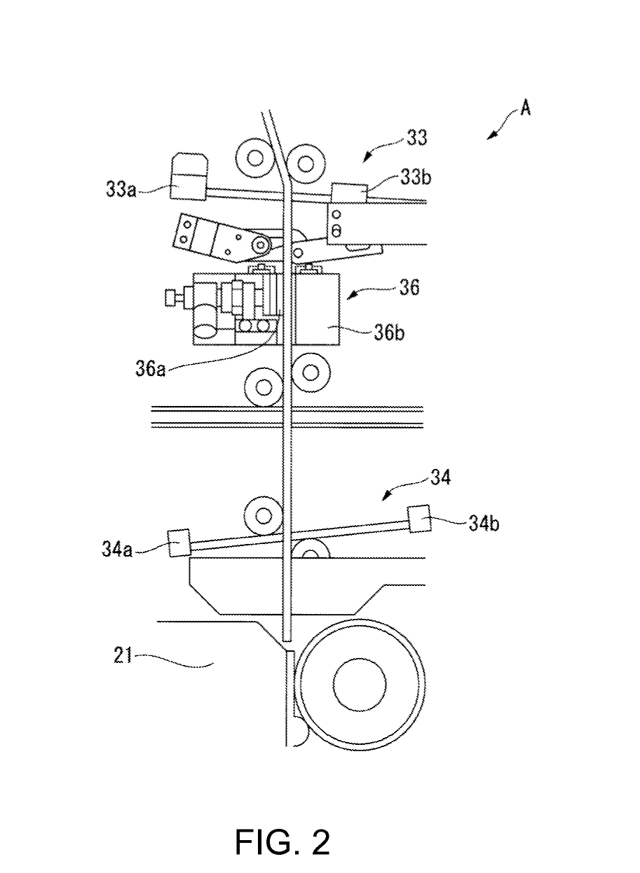

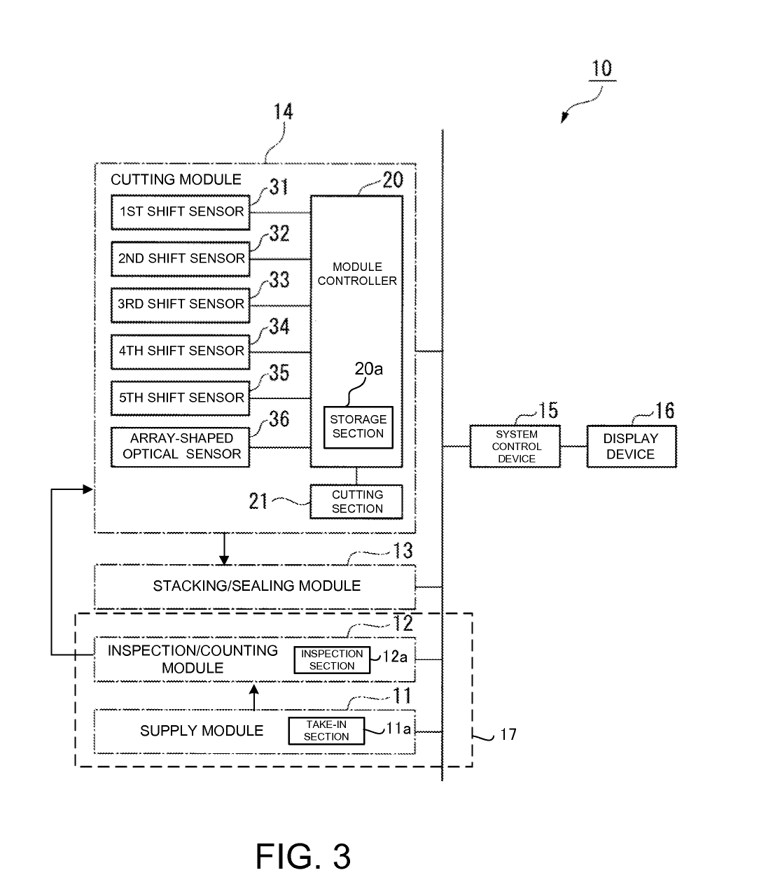

FIG. 1 is a diagram schematically showing a configuration of a cutting module of a sheet processing apparatus 10 of the present embodiment. FIG. 2 is a diagram schematically showing a configuration of a part of the cutting module of the sheet processing apparatus 10 of the present embodiment. FIG. 3 is a diagram schematically showing a configuration of a control system of the sheet processing apparatus 10 of the present embodiment. The sheet processing apparatus 10 handles a bank note which has been sent from each of branches of a plurality of banks, and so on, as a sheet to be processed, and performs the inspection, counting, and sealing, or cutting of the bank note.

As shown in FIG. 3, the sheet processing apparatus 10 is provided with a supply module 11, an inspection/counting module 12, a stacking/sealing module 13, a cutting module 14. The supply module 11 takes in bank notes one by one from a plurality of the bank notes (not shown) which are stacked in a supply section (not shown), at a constant time interval. The inspection/counting module 12 is provided with an inspection section 12a to inspect a bank note. The supply module 11 is provided with a take-in section 12 to take in a bank note. The inspection/counting module 12 performs an inspection such as genuineness determination and fitness determination to the taken-in bank note, and counts the bank notes for each classification, such as for each kind. The stacking/sealing module 13 stacks bank notes to be sealed, such as reusable fit notes (normal notes), for each classification, and seals the stacked bank notes for a prescribed number of sheets (for example, 100 sheets, and so on) by a small band, to create a bank note bundle. The cutting module 14 is provided with a module controller 20 and a cutting section 21, and cuts a bank note to be cut, such as an unfit note (damaged note). That is, the cutting section 21 cuts the bank note in accordance with a result of the inspection by the inspection part 12a. The supply module 11 and the inspection/counting module 12 are connected by a conveying path (not shown), the bank note taken in by the supply module 11 is supplied to the inspection/counting module 12. The inspection/counting module 12 is connected with the cutting module 14 by a conveying path (not shown). In addition, the cutting module 14 is connected with the stacking/sealing module 13 by a conveying path (not shown), The cutting module 14 cuts the bank note according to a result of the inspection of the inspection/counting module 12, and the cutting module 14 outputs the bank note according to a result of the inspection of the inspection/counting module 12. The sheet processing apparatus 10 is provided with at least a main body 17 which includes the take-in section lla and inspection section 12a and the cutting module 17 which includes the module controller 20 and the cutting module.

In addition, the sheet processing apparatus 10 is provided with a system control device 15, a display device 16, an input device (not shown). The system control device 15 is communicably connected to the respective modules 11-14, and integrally controls the respective modules 11-14. The display device 16 accepts various operation inputs by an operator, and displays various operation guides, various information and so on, to the operator. The display device 16 is provided with a touch panel, for example, to detect an input to a button, when an operator contacts the button displayed on the screen and so on. The input device is a key board, for example.

Hereinafter, the cutting module 14 will be described. The cutting module 14 is provided with a module controller 20, and the cutting section 21. The module controller 20 is connected to the system control device 15, and the module controller 20 controls the whole cutting module 14. The cutting section 21 cuts a bank note, to invalidate the bank note.

In addition, as shown in FIG. 1, the cutting module 14 is provided with a first conveying path 22, a second conveying path 23 and a gate 24. A bank note is conveyed on the first conveying path 22 and the second conveying path 23 by a conveying mechanism not shown. On the first conveying path 22, a bank note other than a cutting target, out of bank notes supplied from the inspection/counting module 12 located at an upstream side of a conveying route of the bank note (at the right end of the first conveying path 22 in FIG. 1), is conveyed to the stacking/sealing module 13 located at a downstream side of the conveying route (at the left end of the first conveying path 22 in FIG. 1). The second conveying path 23 branches from the first conveying path 22. On the second conveying path 23, a bank note that is the cutting target, out of the bank notes supplied from the inspection/counting module 12, is conveyed to the cutting section 21. The gate 24 is arranged at a branch point of the first conveying path 22 and the second conveying path 23, and switches the conveying route of the bank note supplied from the inspection/counting module 12 to the first conveying path 22 or the second conveying path 23.

In addition, the bank note other than the cutting target is a normal bank note which is determined as reusable, for example. Although the bank note that is the cutting target is a normal bank note, for example, it is a bank note determined as non-reusable for the reason of the dirt, damage, or the like.

In addition, as shown in FIG. 1 and FIG. 3, the cutting module 14 is provided with a first shift sensor 31, a second shift sensor 32, a third shift sensor 33, a fourth shift sensor 34, and a fifth shift sensor 35. The first shift sensor 31 is arranged at a more upstream side than the gate 24 at the first conveying path 22. The second shift sensor 32, the third shift sensor 33 and the fourth shift sensor 34 are sequentially arranged at the second conveying path 23 between the gate 24 and an inlet port of the cutting section 21, from an upstream side of the second conveying path 23 toward a downstream side of the second conveying path 23. The fifth shift sensor 35 is arranged at the first conveying path 22 at a more downstream side than the gate 24.

The first shift sensor 31 is provided with a light emitting part 31a and a light receiving part 31b which are arranged opposite to each other through the conveying path 22. The second shift sensor 32 is provided with a light emitting part 32a and a light receiving part 32b which are arranged opposite to each other through the second conveying path 23. The third shift sensor 33 is provided with a light emitting part 33a and a light receiving part 33b which are arranged opposite to each other through the second conveying path 23. The fourth shift sensor 34 is provided with a light emitting part 34a and a light receiving part 34b which are arranged opposite to each other through the second conveying path 23. The fifth shift sensor 35 is provided with a light emitting part 35a and a light receiving part 35b which are arranged opposite to each other through the first conveying path 22.

An irradiation light outputted from the light emitting part 31a is received by the light receiving part 31b in a state in which a shield is not present, and is temporarily shielded by a bank note which is conveyed on the first conveying path 22. An irradiation light outputted from the light emitting part 32a is received by the light receiving part 32b in a state in which a shield is not present, and is temporarily shielded by the bank note which is conveyed on the second conveying path 23. An irradiation light outputted from the light emitting part 33a is received by the light receiving part 33b in a state in which a shield is not present, and is temporarily shielded by the bank note which is conveyed on the second conveying path 23. An irradiation light outputted from the light emitting part 34a is received by the light receiving part 34b in a state in which a shield is not present, and is temporarily shielded by the bank note which is conveyed on the second conveying path 23. An irradiation light outputted from the light emitting part 35a is received by the light receiving part 35b in a state in which a shield is not present, and is temporarily shielded by the bank note which is conveyed on the first conveying path 22.

Each of the shift sensors 31-35 outputs a detection signal, and while each of the light receiving parts 31b-35b receives the irradiation light, the detection signal becomes an OFF signal (a low level portion of the detection signal), and while the irradiation light to each of the light receiving parts 31b-35b is shielded, the detection signal becomes an ON signal (a high level portion of the detection signal). For example, a bank note is conveyed on the first conveying path 22 and on the second conveying path 23 to the inlet port of the cutting section 21.

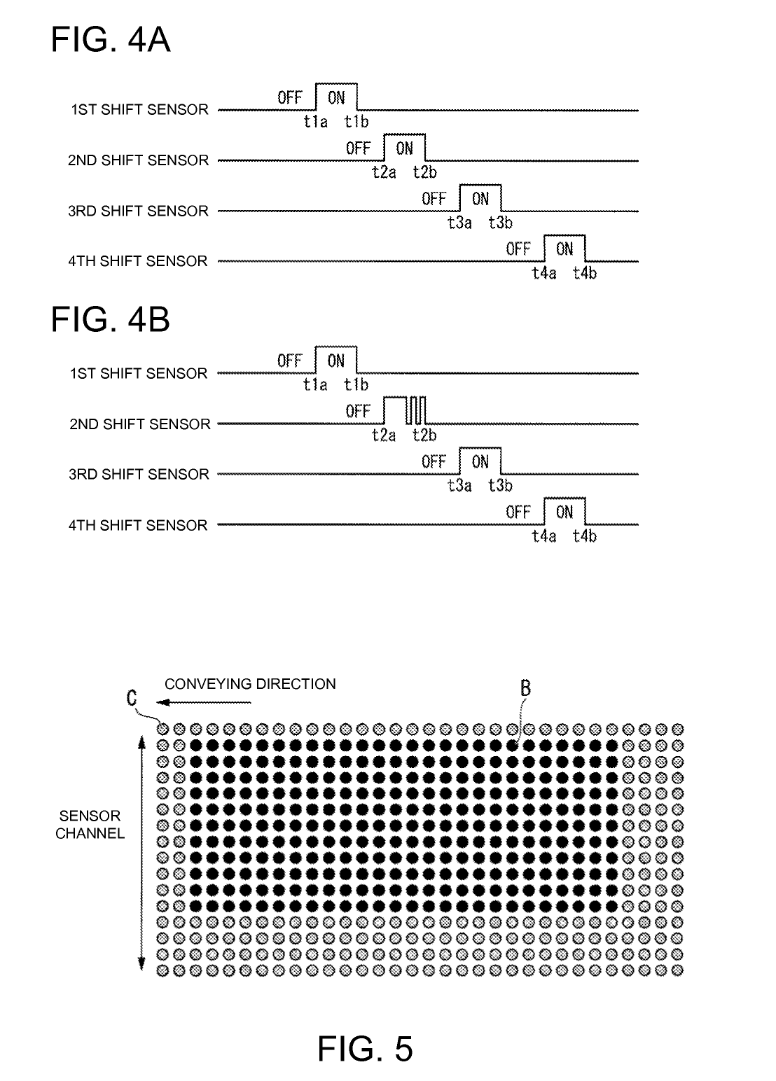

When the reception of the irradiation light by each of the light receiving parts 31b-35b is interrupted, each of the shift sensors 31-35 outputs the ON signal, at each of times t1a-t4a shown in FIG. 4A, for example. The ON signal indicates that a front end of the bank note in the conveying direction has passed through an optical axis of the irradiation light which is outputted from each of the light emitting parts 31a-34a. On the other hand, when the reception of the irradiation light by each of the light receiving parts 31b-34b is resumed, each of the shift sensors 31-34 outputs the OFF signal at each of times t1b-t4b shown in FIG. 4A, for example. The OFF signal indicates that a back end of the bank note in the conveying direction has passed through the optical axis of the irradiation light which is outputted from each of the light emitting parts 31a-34a. In this manner, the respective shift sensors 31-34 are arranged at different positions of the conveying route, and can detect passing timings of the bank note at the positions.

Each of the shift sensors 31-35 is connected to the module controller 20, and the detection signal (the ON signal and the OFF signal) outputted from each of the shift sensors 31-35 is inputted to the module controller 20. By this means, the module controller 20 detects whether or not the bank note has passed through the optical axis of each of the shift sensors 31-35 at a proper timing. The system control device 15 connected to the module controller 20 counts the bank note which is being conveyed on the first conveying path 22, and the bank note which enters the cutting section 21 from the second conveying path 23, based on the detection of passing timings of the bank note by the module controller 20.

In this embodiment, the system control device 15 is a detecting section of the number of conveyed sheets to detect the number of sheets which are conveyed on the conveying route from the inspection/counting module 12 to the cutting section 21. In addition, the module controller 20 has a storage section 20a to store the detection signals outputted from the respective shift sensor 31-35, and the module controller 20 stores the convey history of the bank note in the storage section 20a.

In addition, the module controller 20 grasps a time required for the bank note to pass through the optical axis of each of the shift sensors 31-35, in accordance with a previously known conveying speed of the bank note. That is, the module controller 20 grasps a duration time when the ON signal is outputted from each of the shift sensors 31-35, such as a period from each of the times t1a-t4a to each of the times t1b-t4b as shown in FIG. 4A, for example.

In addition, the module controller 20 grasps a time required for the bank note to pass through each of the spaces between the shift sensors 31-34, in accordance with the previously known conveying speed of the bank note. That is, the module controller 20 grasps a duration time till the ON signal is outputted from each of the shift sensors 32-34 at the downstream side, after the ON signal from each of the shift sensors 31-33 of the upstream side changes to the OFF signal, such as a period from each of the times t1b-t3b to each of the times t2a-t4a, as shown in FIG. 4A, for example.

By this means, the module controller 20 can determine whether or not the passing timing (that is, the convey history of the bank note) of the bank note at the install position of each of the shift sensors 31-35 is proper. In this embodiment, the module controller 20 is a passing timing determination section to determine whether or not the passing timings of the bank note which are detected by a plurality of the sensors are proper. In addition, when detecting that the passing timing of the bank note is not proper, such as the output of the second shift sensor 32 shown in FIG. 4B, for example, the module controller 20 stops the operation of the cutting module 14, specifically the operation of the cutting section 21.

In addition, the system control device 15 connected to the module controller 20 acquires the data of the convey history of the bank note which is stored in the storage section 20a by the module controller 20, and can display a timing chart as shown in FIG. 4A, for example, on the screen of the display device 16.

In addition, as shown in FIG. 1 and FIG. 2, the cutting module 14 is provided with an array-shaped optical sensor 36 which is arranged between the third shift sensor 33 and the fourth shift sensor 34, at the second conveying path 23. That is, the array-shaped optical sensor 36 is arranged between the cutting section 21 and the inspection section 12a. For example, the array-shaped sensor 36 is arranged between the gate 24 and cutting section 21. Specially, the array-shaped sensor 36 is arranged in front of the cutting section 21. FIG. 2 shows a configuration of a part surrounded by a box A in FIG. 1.

The array-shaped optical sensor 36 is provided with a plurality of light emitting parts 36a and a plurality of light receiving parts 36b which are respectively arranged at the both sides of the bank note, along the direction orthogonal to the conveying direction of the bank note which is conveyed on the second conveying path 23. The array-shaped optical sensor 36 composes a line-shaped sensor, for example.

The plurality of light emitting parts 36a and the plurality of light receiving parts 36b are respectively arranged over areas longer than a width of the bank note which is conveyed on the second conveying path 23. The plurality of light emitting parts 36a are provided at one surface side of the faces of the second conveying path 23, and the plurality of light receiving parts 36b are provided at the other surface side of the faces of the second conveying path 23. A pair of the light emitting part 36a and the light receiving part 36b which face each other is used as one sensor channel C. For example, as shown in FIG. 5, by making a time series change in the presence or absence of the reception of the irradiation lights by the respective light receiving parts 36b of the plurality of sensor channels C which are lined in a row, as image data, a shape and a size of a bank note B which has passed through the array-shaped optical sensor 36 can be detected. That is, the array-shaped optical sensor 36 functions as a shape sensor.

The array-shaped optical sensor 36 is connected to the module controller 20, and information regarding the presence or absence of reception of the irradiation light in each of the sensor channels C is inputted to the module controller 20. By this means, the module controller 20 detects the shape and size of the bank note B which has passed through the array-shaped optical sensor 36, and counts the bank note which enters the cutting section 21 from the second conveying path 23, in accordance with this detection result. In this embodiment, the module controller 20 is a detecting section of the number of cut sheets which detects the number of the bank notes (sheets) which have entered the cutting section 21, based on the shape detected by the shape sensor. In addition when the light emitting part 36a is a linear light source, one light emitting part 36a may be provided in common to a plurality of the light receiving parts 36b.

In addition, the image data shown in FIG. 5 shows a time series change in the presence or absence of the respective irradiation lights (for example, a light receiving state is shown by a white circle mark, and a light non-receiving state is shown by a black circle mark) in the plurality of sensor channels C arranged in the direction orthogonal to the conveying direction in a plane parallel to the second conveying path 23, at a prescribed time interval or for each prescribed convey distance of a bank note. The image data shown in FIG. 5 is obtained by arraying the time series change in the presence or absence of the reception of the irradiation lights, along the conveying direction of the bank note.

For example, first when the reception of the irradiation lights by the receiving parts 36b is interrupted in the sensor channels C of at least a prescribed number, out of the plurality of sensor channels C, the module controller 20 detects that the front end of the bank note in the conveying direction has passed through the array-shaped optical sensor 36.

Next, the module controller 20 stores the presence or absence of the reception of the irradiation lights in the plurality of sensor channels C as the time series data in the storage section 20a, each time the bank note is conveyed by a prescribed distance shorter than its own length, after this detection. Furthermore, the module controller 20 arrays the time series data of the plurality of sensor channels C, along the conveying direction of the bank note, for example, to thereby create the image data. And in the created image data, if the detected size of the bank note B (that is, an area of a region where the black circle marks indicating the light non-receiving state of the respective sensor channels C are present) is not less than a prescribed size, the module controller 20 detects that one bank note has passed through the array-shaped optical sensor 36 and has entered the cutting section 21.

In addition, when the reception of the irradiation lights by the receiving parts 36b in the sensor channels C of at least a prescribed number, out of the plurality of sensor channels C is resumed, the module controller 20 detects that the back end of the bank note in the conveying direction has passed through the array-shaped optical sensor 36. And the module controller 20 stores the created image data in the storage section 20a. That is, the module controller 20 stores the shape detected by the shape sensor in the storage section 20a.

In addition, the system control device 15 connected to the module controller 20 acquires the image data stored in the storage section 20a of the module controller 20, and can display the image data as shown in FIG. 5, for example, on the screen of the display device 16.

As described above, the system control device 15 counts the bank note which has entered the cutting section 21, based on the detection of the bank note by each of the shift sensors 31-34. In addition, as described above, the module controller 20 counts the bank note which has entered the cutting section 21 by the shape and size of the bank note, based on the detection of the bank note by the array-shaped optical sensor 36. The system control device 15 and the module controller 20 determine whether or not the respective count values coincide with each other.

In this embodiment, the system control device 15 and the module controller 20 respectively correspond to determination sections which determine whether or not the number of the sheets detected by the detecting section of the number of conveyed sheets, and the number of the sheets detected by the detecting section of the number of cut sheets coincide with each other. For example, each of the system control device 15 and the module controller 20 notifies the other party of the own count value.

When this determination result is “YES”, that is, when the number of the sheets detected by the detecting section of the number of conveyed sheets and the number of the sheets detected by the detecting section of the number of cut sheets coincide with each other, the system control device 15 and the module controller 20 continue the operation of the cutting module 14 and the operation of the sheet processing apparatus 10. When the determination result is “YES”, the system control device 15 and/or the module controller 20 assumes that the respective count values of the system control device 15 and the module controller 20 are normal.

On the other hand, when this determination result is “NO”, that is, when the number of the sheets detected by the detecting section of the number of conveyed sheets and the number of the sheets detected by the detecting section of the number of cut sheets do not coincide with each other, the system control device 15 and the module controller 20 stop the operation of the sheet processing apparatus 10 and the operation of the cutting module 14. That is, in this embodiment, the system control device 15 and the module controller 20 are control sections which stop the processing of the sheet, when it is determined by the determination sections that the number of the sheets detected by the detecting section of the number of conveyed sheets, and the number of the sheets detected by the detecting section of the number of cut sheets do not coincide with each other. The processing of the sheet to be stopped is the processing by the cutting module 14, for example, and specifically is the processing by the cutting section 21. When the determination result is “NO”, any of the count values of the system control device 15 and the module controller 20 is assumed to be abnormal.

In addition, the module controller 20 can display the image data which was stored in the past on the display device 16, and an operator can retroactively confirm the number of the bank notes which entered the cutting section 21, based on the information of the shape and size of the bank note. The display device 16 is a display section.

For example, when an abnormality is found in the convey history of the bank note, such as the detection signal of the second shift sensor 32 shown in FIG. 4B, an operator refers to the image data which has been stored regarding the bank notes before and after this bank note, and thereby can retroactively confirm the number of the bank notes which entered the cutting section 21.

In the embodiment, each of the module controller 20 and the system control device 15 is realized by a computer having a CPU, a RAM, and a ROM and so on to store a program in which predetermined functions are described, for example. The CPU executes the program stored in the ROM, to realize the above-described prescribed function of the module controller 20 or the system control device 15.

As described above, according to the sheet processing apparatus 10 of the present embodiment, since the number of the bank notes which entered the cutting section 21 is counted, by the shape and size of the bank note, based on the detection of the bank note by the array-shaped optical sensor 36, the counting accuracy can be improved. In addition, when an abnormality such as a conveyance jam occurs in the cutting section 21, for example, and even when an abnormality in the count value occurs, an operator can retroactively confirm the number of the bank notes which entered the cutting section 21, based on the image data which was stored in the storage section 20a in the past by the module controller 20. Furthermore, even when various abnormalities occur, the data of the convey history and the image data of the bank note which have been stored in the storage section 20a by the module controller 20 are displayed on the screen of the display device 16, and thereby it becomes possible for an operator to perform counting decision with a high accuracy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the above-described embodiment, the cutting module may be provided with another sensor capable of detecting the shape and size of a bank note, such as a camera, in place of the array-shaped optical sensor 36.

What is claimed is:

1. A sheet processing apparatus comprising:
a main body having a take-in section to take in a sheet and an inspection section to inspect a sheet; and
a cutting module having a cutting section to cut the sheet in accordance with a result of the inspection by the inspection section;
wherein the cutting module includes a shape sensor arranged along a conveying path between the inspection section and the cutting section, to detect a shape of the sheet which enters the cutting section; and
wherein sheet processing apparatus further comprises a first detecting section to detect the number of the sheets which have entered the cutting section, based on the shape of the sheet detected by the shape sensor.

2. The sheet processing apparatus according to claim 1 further comprising:
a storage section to store the shape of the sheet detected by the shape sensor; and
a display section to display the shape of the sheet which is stored in the storage section.

3. The sheet processing apparatus according to claim 1 wherein:
the shape sensor is an array-shaped optical sensor; and
when a size of the sheet detected by the shape sensor is not less than a prescribed value, the first detecting section determines that the one sheet has entered the cutting section.

4. The sheet processing apparatus according to claim 1 further comprising:
a second detecting section to detect the number of the sheets which are conveyed on a conveying route to the cutting section;
a determination section to determine whether or not the number of the sheets detected by the second detecting section, and the number of the sheets detected by the first detecting section coincide with each other; and
a control section to stop an operation of the cutting section, when the determination section determines that the number of the sheets detected by the second detecting section, and the number of the sheets detected by the first detecting section do not coincide with each other.

5. The sheet processing apparatus according to claim 4 further comprising:
a plurality of sensors arranged at different positions of the conveying route, which can detect passing timings of the sheet at the respective positions;
wherein the second detecting section detects the number of the sheets which are conveyed on the conveying route to the cutting section, based on outputs of the sensors which can detect the passing timings of the sheet.

6. The sheet processing apparatus according to claim 5 wherein the second detecting section counts the sheet, based on the passing timings of the sheet which passes through one or a plurality of the sensors out of the plurality of sensors which can detect the passing timings of the sheet.

7. The sheet processing apparatus according to claim 5 further comprising:
a passing timing determination section to determine whether or not the passing timings detected by the plurality of sensors are proper;
wherein when the passing timing determination section determines that the passing timings are not proper, the control section stops the operation of the cutting section.

8. The sheet processing apparatus according to claim 5 further comprising:
a storage section to store detection signals which are outputted from the plurality of sensors.

9. The sheet processing apparatus according to claim 8 further comprising:
a display section to display the passing timings of the sheet which passes through one or a plurality of the sensors out of the plurality of sensors, based on the detection signals which are stored in the storage section to store the detection signals which are outputted from the plurality of sensors.

10. The sheet processing apparatus according to claim 1 further comprising:
a gate to switch a conveying route of sheet to the cutting section or other section;
wherein the shape sensor arranged between the gate and the cutting section

11. The sheet processing apparatus according to claim 5 further comprising:
a gate to switch a conveying route of sheet to the cutting section or other section;
wherein the sensor which can detect the passing timing of the sheet is provided at a conveying path at a more upstream side than the gate, in the conveying route of sheet.

12. The sheet processing apparatus according to claim 11 further comprising:
a conveying path leading to the cutting section, and other conveying path leading to the other section at a downstream side of the gate;
wherein the sensors which can detect the passing timings of the sheet are respectively provided at the conveying path leading to the cutting section, and at the other conveying path leading to the other section, which are provided at the downstream side of the gate.

13. The sheet processing apparatus according to claim 5 wherein the sensors which can detect the passing timings of the sheet are respectively provided before and after the shape sensor at the conveying path.

14. The sheet processing apparatus according to claim 1 further comprising:
a supply module to take in the sheets sequentially one by one from a plurality of the sheets stacked in a supply section at a constant time interval;
an inspection/counting module to perform an inspection of genuine determination and fitness determination to the taken in sheet, and to count the sheet for each classification of the sheet;
a stacking/sealing module to stack reusable sheets for each classification, and to seal the stacked sheets for a prescribed number of sheets by a belt;
a cutting module to cut the sheet in accordance with the inspection by the inspection/counting module;
a system control section to control the supply module, the inspection/counting module, the stacking/sealing module and the cutting module; and
a display device;
wherein the cutting module includes the cutting section, the shape sensor, and the first detecting section.

15. The sheet processing apparatus according to claim 14 wherein:
the cutting module further has a plurality of sensors arranged at different positions of a conveying route, which can detect passing timings of the sheet at the respective positions; and
the system control section has a second detecting section to detect the number of the sheets conveyed on the conveying route to the cutting section, based on the passing timings of the sheet detected by the sensors which can detect the passing timings.

16. The sheet processing apparatus according to claim 15 wherein:
the cutting module has a module controller to control the cutting section; and
the module controller has the first detecting section.

17. The sheet processing apparatus according to claim 16 wherein:
the module controller is connected to the system control section.

18. The sheet processing apparatus according to claim 16 wherein:
the system control section has a determination section to determine whether or not the number of the sheets detected by the second detecting section and the number of the sheets detected by the first detecting section coincide with each other.

19. The sheet processing apparatus according to claim 16 wherein:
the module controller has a determination section to determine whether or not the number of the sheets detected by the second detecting section and the number of the sheets detected by the first detecting section coincide with each other.

20. A sheet processing apparatus comprising:
an inspection section to inspect a sheet;
a cutting section to cut the sheet in accordance with a result of the inspection by the inspection section;
a shape sensor arranged between the inspection section and cutting section, to detect a shape of a sheet which enters the cutting section;
at least one sensor arranged at different positions of a conveying route, which can detect passing timings of the sheet at the positions;
a first detecting section to detect the number of the sheets which have entered the cutting section, based on the shape of the sheet detected by the shape sensor;
a second detecting section to detect the number of the sheets which are conveyed on the conveying route to a front of the cutting section, based on the passing timings of the sheet detected by at least one of the sensors which can detect the passing timings of the sheet;
a determination section to determine whether or not the number of the sheets detected by the second detecting section, and the number of the sheets detected by the first detecting section coincide with each other; and
a control section to stop the cutting section, when the determination section determines that the number of the sheets detected by the second detecting section, and the number of the sheets detected by the first detecting section do not coincide with each other.
